(19) United States
(12) Patent Application Publication
(10) Pub. No.: US 2007/0229298 A1
(43) Pub. Date: Oct. 4, 2007

(54) Method and Arrangement for Stopping Powered Equipment in an Emergency Situation

(76) Inventor: John R. Frederick, Mt. Pleasant, UT (US)

Correspondence Address: BRIAN C. TRASK, 3601 EAST HERMES DRIVE, SALT LAKE CITY, UT, 84124, US

(21) Appl. No.: 11/596,279

(22) PCT Filed: Jan. 18, 2005
(86) PCT No.: PCT/US05/01331

§ 371 Date: Nov. 13, 2006

Related U.S. Application Data
(60) Provisional application No. 60/575,448, filed on May 28, 2004.

(51) Int. Cl. G08C 19/00

(52) U.S. Cl. 340/825.69

(57) ABSTRACT

A method and arrangement for remotely stopping powered equipment in emergency situations. Embodiments of the invention include wearable radio remote transmitters (400) capable of transmitting a signal (500, 505) to powered equipment in the immediate area. A transmitter (400) desirably is located such that it can be quickly activated by the person wearing the transmitter, and may be equipped with a shock detection device capable of automatically activating the radio transmitter Powered equipment operating in the vicinity of transmitter-equipped personnel are fitted with receivers, electronics, actuator, batteries and/or electrical connections, as needed, to shutdown the equipment upon receiving a radio signal from a transmitter Sometimes receivers and amplifiers are located such that a transmitter's signal sent from any location in the area will reach all relevant equipment receivers with sufficient energy to activate the shutdown procedure. A preferred embodiment may include a manually activated transmitter (400) attached to a person's clothing and receivers and actuators mounted on all powered equipment within line-of-sight of this person.

### PRIORITY CLAIM

This application claims the benefit of the filing date of U.S. Provisional Patent Application Ser. No. 60/575,448, filed May 28, 2004, for “Personal Radio Emergency Stop (PRES) Concept”.

### TECHNICAL FIELD

This invention relates generally to safety devices and methods operable to stop equipment or machinery to protect personnel in the vicinity of such equipment and/or local environmental hazzards.

### BACKGROUND

In many situations involving use of machinery or equipment, the operator of the potentially heavy powered machinery, or other equipment, is the only person with routine access to devices capable of quickly stopping the specific powered equipment this person is operating. In general, the operator is onboard the equipment using direct mechanical controls to operate the machine. Sometimes, the operator may be operating by radio remote control while in direct sight of the equipment or be using video and audio equipment for reference and remote control input. The operator may also be remote from the equipment using direct hard links such as control electrical wiring. In all cases, the known art provides only the operator with consistent and ergonomic access to devices capable of stopping the specific equipment in an emergency situation. Personnel in the vicinity of the powered equipment may become endangered by the operation of that equipment.

For purpose of this disclosure, close proximity may be defined as the space in the vicinity of powered equipment where a person could conceivably be injured if any type of erroneous operation occurred. Ergonomic access may be defined as being provided when personnel can access and activate shut-down devices in less than two seconds. Immediate area may be regarded as the area and space around powered equipment wherein a person can detect developing emergency situations. Onboard generally means the operator is physically on/in the equipment or the power source is located on/in the equipment. Operator, or specific equipment operator includes the person controlling the specific equipment. Person, or personnel, include the person/people in the area associated with the activity involving powered equipment, e.g. workers, operators, managers, visitors, etc. Power center/distribution box means an electrical distribution assembly that divides, and/or modifies, incoming electrical power feed to a plurality of electrical circuits. Powered equipment means equipment with a power source other than manual, e.g. electrical, hydraulic, compressed air, diesel, gasoline, etc., that would conceivably injure personnel or damage infrastructure other equipment, the environment, or otherwise cause financial loss. And finally, remote means the specific equipment operator is not onboard the equipment. In such case, control may be by way of: electrical umbilical, radio, infrared, programmed computer, autonomous operation, etc.

Known prior art provides no direct method for the potentially endangered personnel, other than the specific equipment operator, to cause an emergency stop effective to stop the relevant equipment in time to prevent accident or injury in an emergency situation. Such prior art severely limits the ability of endangered personnel to stop powered equipment. They must communicate verbally and/or visually with the specific equipment operator, who may not even be within the endangered person's field of view or voice range when equipment is operating. In addition, prior art leaves the endangered person in an emergency situation where they are simultaneously trying to avoid an imminent accident while attempting to gain the attention of a specific equipment operator, who is the only person with a direct means of stopping the equipment in an emergency situation. In addition, this may all be happening in a very noisy, dark and confined environment.

### DISCLOSURE OF THE INVENTION

The invention provides a method for stopping one or more pieces of powered equipment, by an individual disposed at a location remote from a conventional control station for an operator of that equipment. Steps of the method include providing the individual with a portable radio transmitter capable of transmitting a first stop signal; and providing a first receiver and actuator system operably in association with a first piece of the equipment effective to cause an emergency stop of the equipment upon reception by the receiver of the stop signal. The individual then simply activates the transmitter to transmit the first stop signal upon need for causing an emergency stop. Certain desirable transmitters may automatically transmit a signal without intervention of the person associated with the transmitter, such as in the case of an electrical discharge or other local event. Sometimes, the transmitter is capable of also transmitting a second stop signal. The method may further include providing a second receiver and actuator system operably in association with a second piece of the equipment effective to cause an emergency stop of the second piece of equipment upon reception by the second receiver of the second stop signal. In an alternative arrangement, the method may include providing a second receiver and actuator system operably in association with a second piece of said equipment effective to cause an emergency stop of the second piece of equipment upon reception by the second receiver of the first stop signal.

Desirable embodiments of the method include providing a plurality of receiver and actuator systems operably in association with a plurality of pieces of equipment effective to cause an emergency stop of each of such pieces of equipment upon reception by its associated receiver of a transmitted stop signal. Further, the method may provide a portable radio transmitter to each of a plurality of individuals, each transmitter being capable of transmitting a first stop signal effective to cause an emergency stop. Naturally, any of the individuals may then actuate their associated transmitter to transmit a stop signal upon need for causing an emergency stop of the equipment. To cause an emergency stop, operable actuator systems may either open or close an electrical circuit. One actuator system within contemplation includes an electromechanical device, such as a solenoid.

An individual may actuate his personal portable transmitter by way of an action selected from the group comprising: contact between a control portion of the transmitter and structure of the individual's finger, hand, chin, or other body part; contact between a portion of the transmitter and a portion of other structure; biosensor feedback indicating health status of the individual; feedback from a sensor effective to detect excessive electrical energy in the vicinity of the individual; and voice command imparted by the individual. As an example, an emergency stop signal may be transmitted responsive to the individual receiving an electric shock to de-energize electrical circuits and stop further electrical activity in the vicinity of the individual.

Certain embodiments of the invention include a relay assembly effective to activate systems operable to cause an emergency stop. Desirably, a relay assembly is effective, responsive to reception thereby of a stop signal, to broadcast a relay radio signal, with the relay radio signal being effective to increase a distance of effective operation of the stop signal. Sometimes, a plurality of relay assemblies are arranged to increase a distance of effective operation of a first signal and operable to relay the first signal to a plurality of receiver and actuator systems associated with a plurality of pieces of powered equipment effective to cause an emergency stop of that equipment responsive to the first signal.

One currently preferred embodiment of the invention is employed to advantage as an improvement in an underground mine having powered equipment adapted for motion under guidance of an operator, and with one or more individuals being disposed in the vicinity of that equipment. The improvement includes at least one radio signal transmitter carried by at least one of the one or more individuals. Also included are a radio signal receiver adapted to receive an emergency stop radio signal broadcast from the transmitter and an actuator operable to effect an emergency stop of the equipment responsive to the emergency stop radio signal. In general, the transmitter is adapted for actuation, to broadcast the emergency stop radio signal, by the individual performing an action selected from the group including: contact between a control portion of the transmitter and structure comprising the individual's finger, hand, chin, or other body part; contact between a portion of the transmitter and a portion of other structure; biosensor feedback indicating health status of the individual; feedback from a sensor effective to detect excessive electrical energy in the vicinity of the individual; and voice command imparted by the individual. The improvement may also include one or more relay assembly effective, responsive to reception thereby of the emergency stop radio signal, to broadcast a relay radio signal, the relay radio signal being effective to increase a distance of effective operation of the emergency stop radio signal. Furthermore, a plurality of relay assemblies may be arranged to increase a distance of effective operation of the emergency stop radio signal and operable to relay the emergency stop radio signal to a plurality of receiver and actuator systems associated with a plurality of pieces of powered equipment effective to cause an emergency stop of the equipment responsive to the emergency stop radio signal.

These features, advantages, and alternative aspects of the present invention will be apparent to those skilled in the art from a consideration of the following detailed description taken in combination with the accompanying drawings.

### BRIEF DESCRIPTION OF THE DRAWINGS

In the drawings, which illustrate what are currently considered to be the best modes for carrying out the invention:

FIG. 1 is a side view of an operable transmitter;

FIG. 2 is a side view of an operable receiver/actuator;

FIG. 3 is a side view of an operable amplifier/signal booster;

FIG. 4 is a generalized representation of one type of arrangement including the invention with one or more repeaters; and

FIG. 5 is a plan view of a typical underground coal mining section showing the invention in use in association with powered equipment and personnel.

### MODES FOR CARRYING OUT THE INVENTION

Reference will now be made to the drawings in which the various elements of the invention will be given numerical designations and in which the invention will be discussed so as to enable one skilled in the art to make and use the invention. It is to be understood that the following description is only exemplary of the principles of the present invention, and should not be viewed as narrowing the claims which follow.

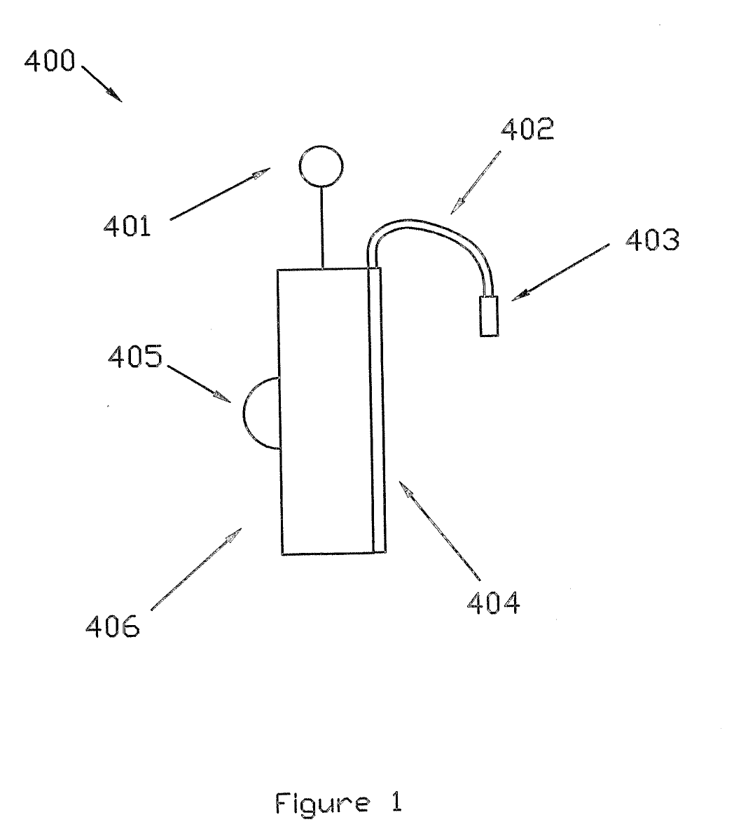

Turning first to FIG. 1, there is shown a personal wearable transmitter apparatus 400. The individual components of this device 400 may be based on prior technology. It is generally comprised of electrical components needed to generate and remotely transmit a specified radio signal when switch 405 is depressed. The enclosure 406 is designed to protect the internal components from all manner of environmental damage that may be found in mining, construction, manufacturing and other activities where humans are in close proximity to powered equipment. An antenna 401 may or may not be used to increase radio signal strength and distance. With this invention, an endangered person could simply press switch 405 on their personal transmitter 400 to quickly stop the equipment that is endangering them. Also, any other personnel in the area could quickly stop the equipment in the same manner if they observed or were otherwise alerted to the emergency situation. It is desirable to equip all personnel in the area of powered equipment with a radio transmitter capable of activating the components necessary to stop all powered equipment within their immediate area. Circumstances may dictate exceptions to this. However, one intent of this invention is to permit any of the personnel in the area of powered equipment to stop such equipment in an emergency situation. Any person in the area could be the one to notice an emergency situation developing and, with the quick stop of all powered equipment, may be able to prevent an accident from happening or at least minimize the injuries and damage.

A plurality of methods may be used to attach the transmitter apparatus 400 to a person or their clothing. In the preferred embodiment, the transmitter is connected to a strap 402 that is connected to one end of a buckle assembly 403, having a means to adjust the strap length. The other end of the buckle assembly is attached to the persons clothing on either shoulder near the neck or collar area. In the preferred embodiment an additional attachment method using Velcro type material 404, fixed to the side of the device and to the person's clothing, is used to hold the device in a particular position on a person's upper chest area where the switch 405 can be depressed with the person's chin. This embodiment is preferred in order to allow the person to depress the switch even if their hands are trapped or otherwise prevented from reaching the switch 405.

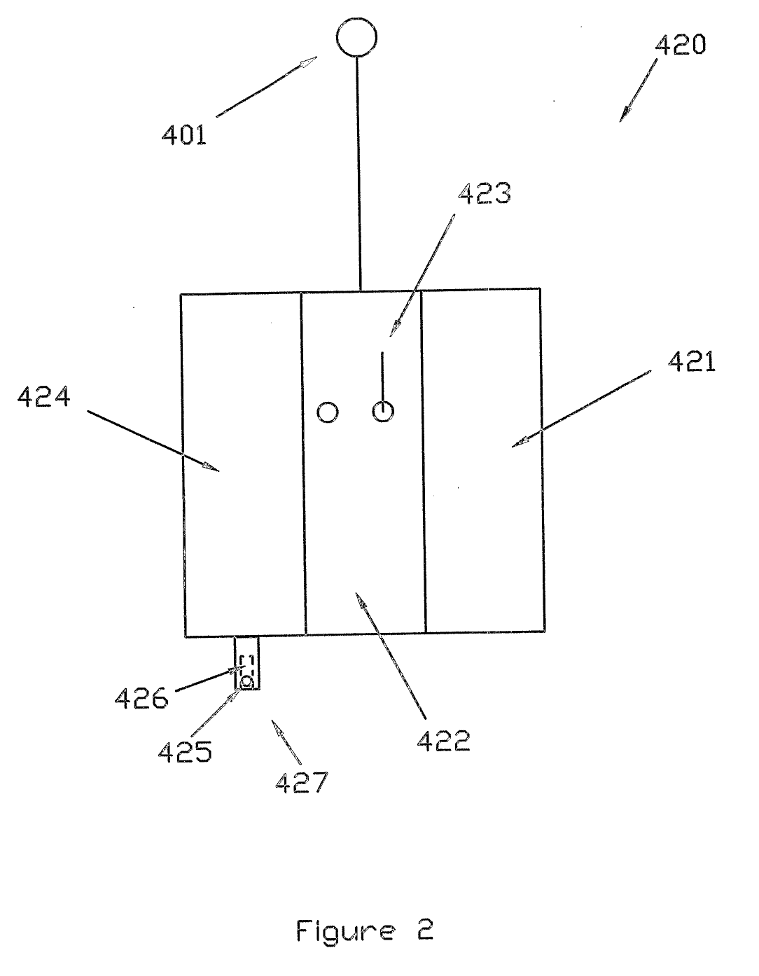

In FIG. 2 is shown a receiver/actuator device 420 used to activate mechanisms that will connect or disconnect electrical circuits. The components of this device may also be based on prior technology. It generally contains a section 421 for storage of and/or connection to internal or external battery or other power sources. Another section 422 contains the electronic components necessary to receive the radio signal from the transmitter 400 and process this signal to electronically open or close electrical switch 423. Where the disconnection or connection (off or on) of an electrical circuit can shutdown powered equipment, switch 423 is integrated into the machine's electrical circuit such that activation of switch 423 will in turn stop the associated powered equipment.

Also shown in FIG. 2 is an actuator mechanism section 424 that is activated by opening or closing switch 423. Powered equipment that requires the movement of a mechanical device may use section 424. These devices may include, but are not limited to electric solenoids, air and/or fluid powered valves, electrically actuated valves and/or electric motors.

In one preferred embodiment of an actuator 424, an electric solenoid is used to provide linear mechanical movement of piston 427 which has a threaded hole 425 normal to the piston axis and a smooth hole 426 that is drilled from end center of the piston past hole 425 along the long axis of the piston. A cable is inserted into hole 426 and a set screw is turned into threaded hole 425 to attach the cable to piston 427. The cable can then be connected to a plurality of mechanical devices that will shutdown the powered equipment. The electric solenoid could pull the cable which is attached to an electrical switch or breaker which would stop all equipment on the relative electrical circuit. It may also involve using the cable to close a valve that will stop the flow of diesel fuel to an engine and cause the engine and related equipment to stop. The cable could be used to close a valve that will stop flow of hydraulic fluids or compressed air used to power equipment. A plurality of devices could be used in place of the cable (e.g., rods of any composition, devices used to transmit force, devices used to transmit and multiply force, movement of mechanisms that in turn activate other electrical or electronic devices etc.).

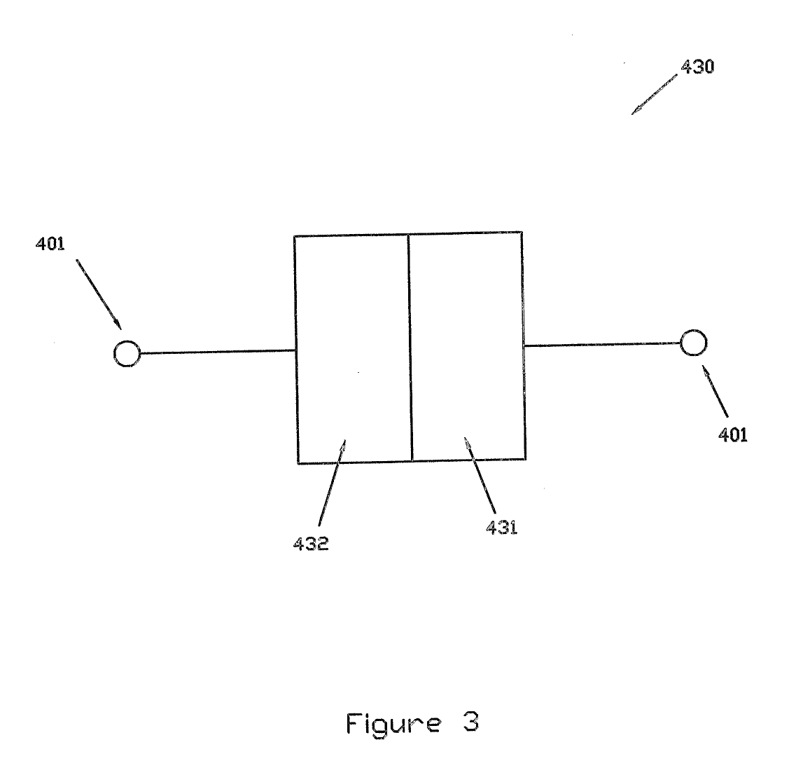

Sometimes, to reach critical powered equipment shutdown mechanisms, radio signal amplifiers (boosters), as shown in FIG. 3, may be used. These devices generally include antennae 401, receiver assemblies 431 and booster transmitter assemblies 432.

One benefit of this invention is an expected reduction in the number and severity of accidents to humans caused by powered equipment. Any powered equipment that could conceivably injure or contribute to injuring people should be equipped with the appropriate receiver and actuator device 420. All personnel in close proximity, near enough to be injured by any conceivable human, equipment or environmental action, should be equipped with a transmitter 400 for stopping powered equipment in an emergency situation.

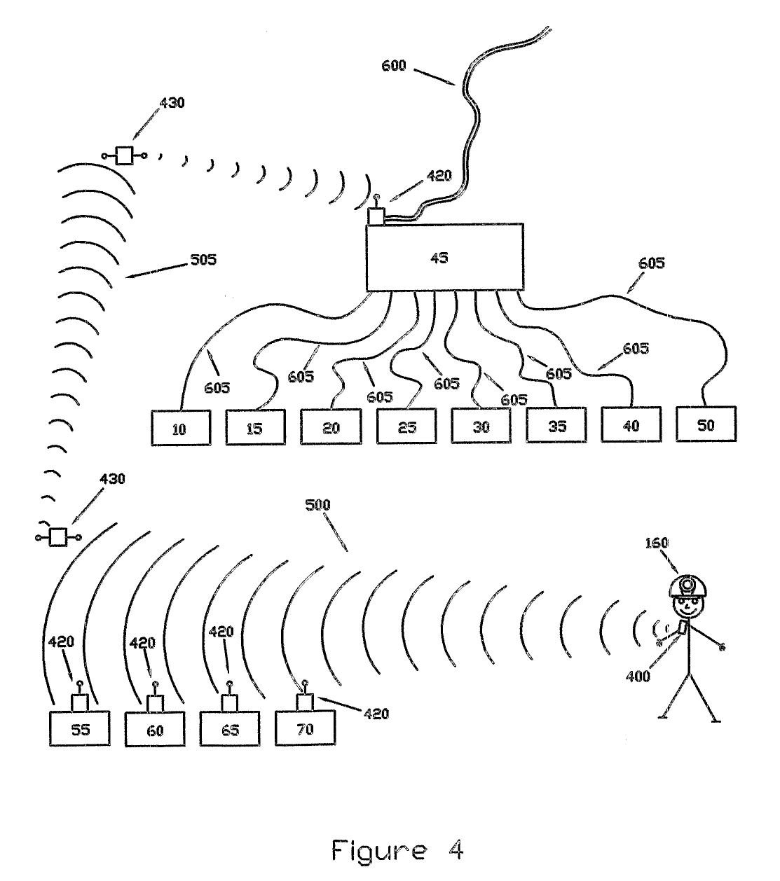

FIG. 4 illustrates one example of a method and arrangement for stopping equipment in an emergency situation. This illustrates the variety of tethered electrically powered equipment; other powered equipment such as water and hydraulic pumps 10, shuttle car #1 15, shuttle car #2 20, shuttle car #3 25, continuous miner 30, roof bolter 35, feeder breaker 40, conveyor belt 50. Equipment with onboard power sources (e.g., battery, diesel, hydrogen etc.) are depicted as supply truck and fork lift 55, scoop or LHD 60, personnel carrier 65 and lube truck 70. The underground miner (person) is represented by the stick FIG. 160. The person is wearing the transmitter device 400. In an emergency situation, the person 160 depresses switch 405 which activates the transmitter 400 sending a radio signal 500 in all directions.

For clarity purposes, FIG. 4 indicates a directional radio signal. However, the signal is transmitted in all directions from the antennae. This signal activates the individual receivers and actuators of the onboard powered equipment 55-70, stopping this equipment and activates the receiver and actuator devices 420 which stops the tethered electrical equipment 10-50 by disconnecting the flow of electricity from the main feed line 600 to all individual equipment feed lines 605. FIG. 4 also illustrates the use of radio signal amplifiers (boosters) that may be needed to provide adequate activation signal strength to the receivers and actuator devices 420 located on the electrical distribution box 45. Individual receiver and actuator devices 420 may be mounted on a plurality of tethered electrically powered equipment.

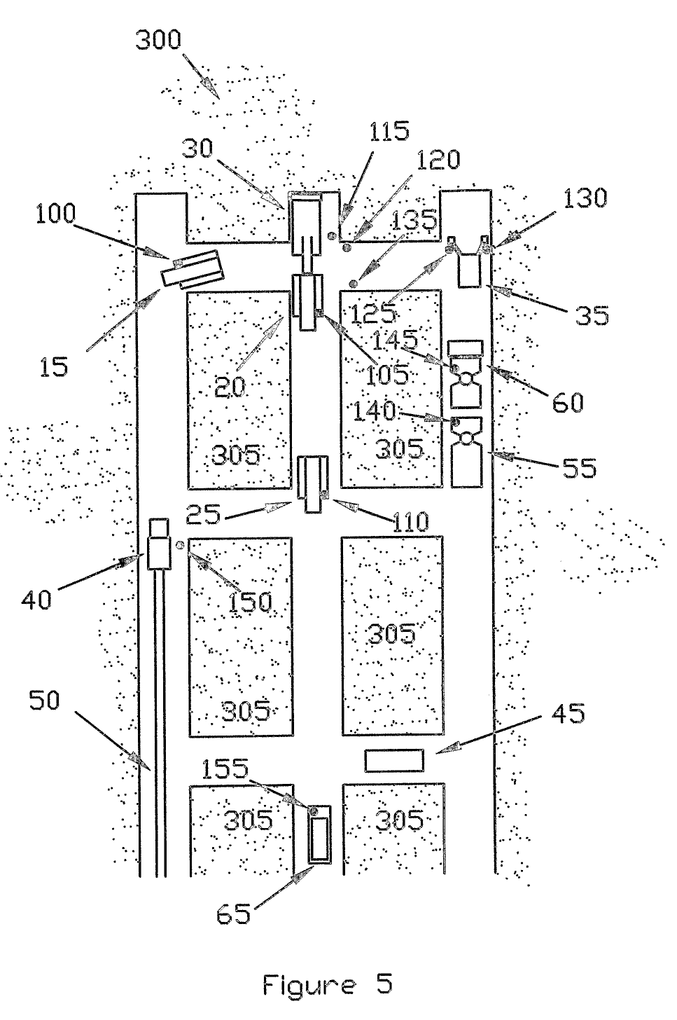

In FIG. 5, a plan view of a typical underground coal mining section is shown. This depicts the extremely cramped operating area in which personnel 100-160 and large heavy duty equipment 15-65 must work together. The narrow entries and crosscuts (underground openings made during mining) have been mined in the coal seam 300 and are generally made as narrow as possible to help stabilize the mine roof. While operating large equipment 15-65, the operators 100, 105, 110, 125,130,140,145 and 155 areas of vision are extremely limited by cramped and enclosed operator compartments, dust, smoke, poor lighting and equipment size.

FIG. 5 shows only the typical personnel that are in the area on a day-to-day basis. It does not indicate the numerous visits from other personnel. These people are generally trying to observe mining operations, survey, repair miscellaneous equipment, and conduct required regulatory inspections, to name a few. Also, these people may not be fully aware of the movements and hazards associated with the powered equipment. Equipment operators may not always be aware of the location of these people due to the issues given above. It is critical for these people to be carrying a personal emergency stop transmitter 400 since they have no direct method of quickly stopping powered equipment in an emergency situation.

This invention can also significantly reduce accidents and injuries associated with movement of cables and components associated with powered equipment. The trailing (tethered) cables 605 are attached to a section power center 45 and then, typically for several hundred feet, are either laid on the mine floor or hung along the mine roof and/or ribs to equipment 10-50. Equipment fitted with cable reels 15, 20, 25, 35 spool cable 605 in and out subject to the direction of travel of associated equipment. However, the cable reel puts enough tension on the cable 605 to cause sudden vertical as well as horizontal movement. Equipment without cable reels 30 and 40 must drag their trailing cable 605 generally with manual help from personnel and other equipment. Movement of these cables 605 is a hazard to personnel that are in close proximity. In the event a person becomes trapped, entangled or otherwise put in a dangerous situation with respect to these cables 605, they can quickly stop the equipment 10-50 and associated cable 605 movement by activating switch 405. In many situations, this person(s) may not be in visual or audible range of the specific equipment operator.

This invention will also help to reduce accidental damage to equipment 10-70 and trailing cables 605 caused by mobile equipment. Personnel that observe a developing situation that may damage equipment, related components or infrastructure can quickly shutdown the equipment and correct the situation before the damage occurs.

This invention is also capable of significantly reducing accidents, injuries and fatalities in other applications where human beings are required to be or are otherwise in close proximity to powered equipment. A few examples include; surface mining, construction, manufacturing, material handling, testing, training and general maintenance in and around any powered equipment.

In one preferred embodiment of this invention, regulatory authorities will designate a specific radio frequency range for this technology. In doing so, the technology should become universal across all applications, helping to reduce cost and maximize efficiency of use.

While the invention has been described in particular with reference to certain illustrated embodiments, such is not intended to limit the scope of the invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### INDUSTRIAL APPLICABILITY

This invention is applicable to any application in which human beings are within the immediate area of any powered equipment. It may also be used to help prevent damage to equipment and facilities, even if a human is not in danger. Industries such as mining, construction and manufacturing are considered to be the primary industrial applications for this invention.

1. A method for stopping one or more pieces of powered equipment, by an individual disposed at a location remote from a traditional control station for an operator of that equipment, the method comprising:
providing said individual with a portable radio transmitter capable of transmitting a first stop signal at a fixed frequency; and
providing a first receiver and actuator system operably in association with a first piece of said equipment effective to cause an emergency stop of said first piece of equipment upon reception by said receiver of said first stop signal;
providing a second receiver and actuator system operably in association with a second piece of said equipment effective to cause an emergency stop of said second piece of equipment upon reception by said second receiver of said first stop signal; and
said individual actuating said transmitter to transmit said first stop signal upon need for causing an emergency stop.

2. The method according to claim 1, wherein:
said transmitter is capable of transmitting a second stop signal; and further comprising:
providing a third receiver and actuator system operably in association with a third piece of said equipment effective to cause an emergency stop of said third piece of equipment upon reception by said third receiver of said second stop signal; and
said individual actuating said transmitter to transmit said second stop signal upon need for causing an emergency stop of said third piece of equipment.

3. (canceled)

4. The method according to claim 1, further comprising:
providing a plurality of receiver and actuator systems operably in association with a plurality of pieces of said equipment effective to cause an emergency stop of each of such pieces of equipment upon reception by its associated receiver of the same transmitted stop signal from any one of a plurality of portable radio transmitters.

5. The method according to claim 1, further comprising:
providing a portable radio transmitter to each of a plurality of individuals, each said transmitter being capable of transmitting said first stop signal effective to cause said emergency stop; and
any of said plurality of individuals actuating their associated transmitter to transmit a stop signal upon need for causing an emergency stop of said equipment.

6. The method according to claim 1, wherein:
said individual may actuate said transmitter by way of an action selected from the group comprising: biosensor feedback indicating health status of said individual; feedback from a sensor effective to detect excessive electrical energy in the vicinity of said individual; and voice command imparted by said individual.

7. The method according to claim 1, wherein:
said actuator system is operable to open an electric circuit effective to cause said emergency stop.

8. The method according to claim 1, wherein:
said actuator system is operable to close an electric circuit effective to cause said emergency stop.

9. The method according to claim 1, wherein:
said actuator system comprises an electro-mechanical device operable to cause said emergency stop.

10. The method according to claim 1, wherein:
transmission of said first stop signal is effective to de-energize electrical circuits responsive to said individual receiving an electric shock.

11. The method according to claim 1, further comprising:
providing a relay assembly effective to activate systems operable to cause said emergency stop.

12. The method according to claim 11, wherein:
said relay assembly is effective, responsive to reception thereby of said first stop signal, to broadcast a relay radio signal, said relay radio signal being effective to increase a distance of effective operation of said first stop signal.

13. The method according to claim 12, further comprising:
providing a plurality of relay assemblies arranged to increase a distance of effective operation of said first signal and operable to relay said first signal to a plurality of receiver and actuator systems associated with a plurality of pieces of powered equipment effective to cause an emergency stop of said equipment responsive to said first signal.

14. In an underground mine having powered equipment adapted for motion under guidance of an operator, and a plurality of individuals disposed in the vicinity of that equipment, the improvement comprising:
a plurality of radio signal transmitters, each transmitter being operable to transmit the same emergency stop radio signal at a fixed frequency, and one transmitter being carried by each of said individuals;
a radio signal receiver adapted to receive said emergency stop radio signal broadcast from any one of said transmitters; and
an actuator associated with said receiver and said equipment and operable to effect an emergency stop of said equipment responsive to said emergency stop radio signal.

15. The improvement according to claim 14, wherein:
each said transmitter is adapted for actuation by an individual, to broadcast said emergency stop radio signal, by way of an action selected from the group comprising: biosensor feedback indicating health status of said individual; feedback from a sensor effective to detect excessive electrical energy in the vicinity of said individual; and voice command imparted by said individual.

16. The improvement according to claim 14, further comprising:
a relay assembly effective, responsive to reception thereby of said emergency stop radio signal, to broadcast a relay radio signal, said relay radio signal being effective to increase a distance of effective operation of said emergency stop radio signal.

17. The improvement according to claim 14, further comprising:
a plurality of relay assemblies arranged to increase a distance of effective operation of said emergency stop radio signal and operable to relay said emergency stop radio signal to a plurality of receiver and actuator systems associated with a plurality of pieces of powered equipment effective to cause an emergency stop of all of said equipment responsive to said emergency stop radio signal.

18. In a plurality of pieces of powered equipment, with each piece of such equipment being adapted for motion under guidance of an operator located at an operator position, and with one or more individuals disposed in the vicinity of, but lacking guidance control over, that equipment, the improvement comprising:
a first radio signal transmitter carried by one of said one or more individuals, said transmitter being adapted for broadcasting at a fixed emergency stop frequency;
a first radio signal receiver adapted to receive an emergency stop radio signal broadcast from said first transmitter;
a second radio signal receiver adapted to receive said emergency stop radio signal broadcast from said first transmitter; and
an actuator associated with each said first and second receiver and corresponding first and second pieces of said equipment, each said actuator being operable to effect an emergency stop of its associated piece of said equipment responsive to said emergency stop radio signal.

19. The improvement according to claim 18, further comprising:
a second radio signal transmitter adapted to transmit the same emergency stop radio signal transmitted by said first transmitter, said second transmitter being carried by a second one of said individuals, wherein;
actuation of either one of said first and second transmitter to cause said emergency stop radio signal is effective to cause an emergency stop of both of said first and second pieces of equipment.
